(19) United States
(12) Patent Application Publication
(10) Pub. No.: US 2005/0017502 A1
(43) Pub. Date: Jan. 27, 2005

(54) Foldable data-card assembly

(76) Inventor: Sean Keith Chariker, Alpharetta, GA (US)

Correspondence Address: J. Michael Martinez de Andino, Esq.;HUNTON & WILLIAMS, Riverfront Plaza, East Tower, 951 East Byrd Street, Richmond, VA, 23219-4074, US

(21) Appl. No.: 10/623,688

(22) Filed: Jul. 21, 2003

(51) Int. Cl. B42D 15/00

(52) U.S. Cl. 283/106

(57) ABSTRACT

A foldable data card assembly is disclosed. The assembly is a sheet which has a base portion and a first and second lateral portion which extend from the base portion. The second lateral portion folds toward the base portion to a stowed position, while the first lateral portion folds toward the base portion and the stowed second lateral position to a covering position. A first and second line of weakness cross at least the base portion and first lateral portion and an adhesive is disposed between the lines of weakness and the edge to seal the assembly. The assembly is opened by removing tearing away portions of the sheet above and below the lines of weakness to remove the portions of the sheet which were adhered together. The assembly may then be opened to gain access to the second lateral portion which contains information relating to a data card.

### BACKGROUND OF THE INVENTION

Data cards such as gift cards and telephone calling cards permit consumers to prepay for goods or services. An account associated with the data card is debited as goods and services are purchased by using the card.

In many instances the data cards are available for purchase directly from large retail displays. For security purposes, the data cards may be unactivated or have no value associated with them until a purchaser pays a retailer to activate the card or to associate a certain value with the card. Despite these security features to discourage theft, many would-be criminals still steal the data cards, often by removing the card from its packaging.

Accordingly, it may be desirable to provide a data card which is concealed within its packaging to discourage theft of the cards. It may also be desirable to provide a foldable data card assembly in which the data card and its packaging may be manufactured at the same time from the same material and which may decrease production costs.

### SUMMARY OF THE INVENTION

A foldable data card assembly is disclosed. The assembly comprises a sheet having an upper and lower surface, a base portion having spaced apart first and second lateral sides and spaced apart top and bottom base edges, a first lateral portion extending laterally away from the first lateral side of the base portion, and a second lateral portion extending laterally away from the second lateral side of the base portion. The assembly further comprises a first line of weakness formed in the base portion and the first lateral portion, the first line of weakness being substantially parallel to the top base edge, and a second line of weakness formed in the base portion and the first lateral portion, the second line of weakness being substantially parallel to the bottom base edge. An adhesive is disposed on at least a portion of an area of the upper surface of the base portion intermediate the first line of weakness and the top base edge and on at least a portion of an area of the upper surface of the base portion intermediate the second line of weakness and the bottom base edge. The second lateral portion is foldable along a first fold line to a stowed position wherein the second lateral portion overlies at least a portion of the upper surface of the base portion and wherein the first lateral portion is foldable along a second fold line to a covering position wherein the first lateral portion overlies at least a portion of the second lateral position when the second lateral portion is in its stowed position.

### BRIEF DESCRIPTION OF THE DRAWINGS

FIG. 1a is a foldable data card assembly in accordance with an exemplary embodiment of the invention.

FIG. 1b is a foldable data card assembly in accordance with another exemplary embodiment of the invention.

FIG. 2 is the foldable data card assembly of FIG. 1a with a second lateral portion shown in a covering position.

FIG. 3 is a foldable data card assembly demonstrating one aspect of an exemplary embodiment of the invention.

FIG. 4 is a foldable data card assembly demonstrating yet another aspect of an exemplary embodiment of the invention.

FIG. 5a is a foldable data card assembly in accordance with yet another exemplary embodiment of the invention.

FIG. 5b is a foldable data card assembly in accordance with still another exemplary embodiment of the invention.

FIG. 6 is a foldable data card assembly in accordance with an exemplary embodiment of the invention.

### DETAILED DESCRIPTION OF EXEMPLARY EMBODIMENTS

The present invention is directed to foldable data card assemblies. Data card assemblies according to the invention may be formed from a sheet of foldable material configured for development into a secure protective package for a data card. The sheet is preferably formed from a thin and resilient material that is selectively foldable if creased but otherwise remains substantially rigid. The sheet may be configured so as to have three portions: a base portion, a first lateral portion and a second lateral portion. The second lateral portion may be or may include a data card that may be activated for use in purchasing goods or services. The data card assembly is configured so that the second lateral portion, including the data card, may be folded into a stowed position over the base portion and the first lateral portion may be folded into a covering position over the second lateral portion. As will be discussed in more detail, an adhesive may be provided that will keep the first lateral portion in its covering position, thus providing a secure package for the data card.

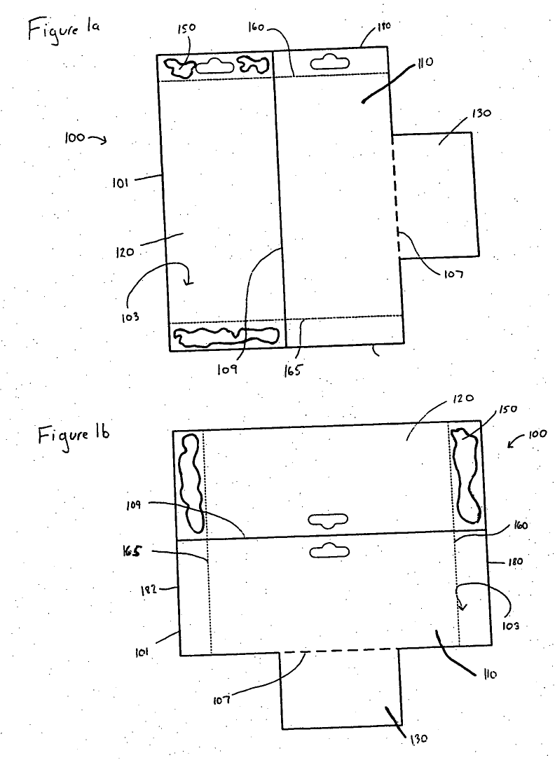

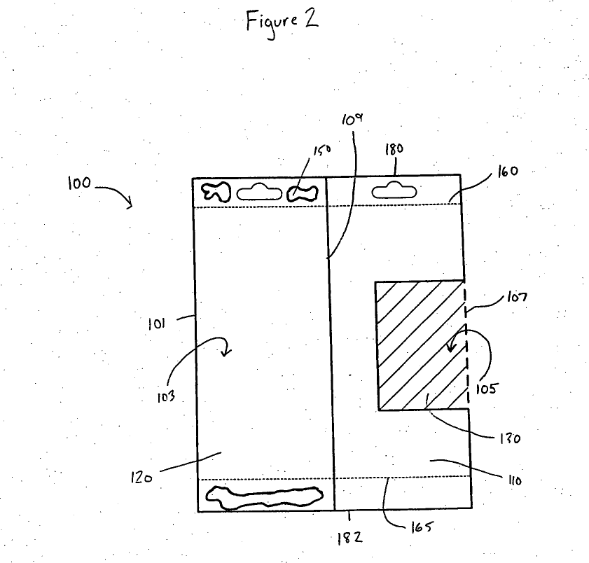

With reference to FIGS. 1-6, embodiments of the invention will now be discussed in more detail. Data card assemblies according to the invention may comprise sheets formed from any foldable material. Preferably the sheet is thin and resilient such that it may be folded into three sections. Although any material meeting these desired characteristics falls within the scope of the invention, particularly suitable material may include non-corrugated cardboard, cover stock, card stock, or plastic sheets such as polypropylene, polyethylene or polystyrene, for example.

In one exemplary embodiment as shown in FIG. 1a, a foldable data card assembly 100 comprises a sheet 101 having three portions, a base portion 110 and a first lateral portion 120, which together form the packaging portion of the assembly, and a second lateral portion 130 which may be a data card portion of the assembly. The lateral portions 120, 130 are on opposite sides of the base portion 110 and extend laterally away from the base portion 110. By manufacturing both a data card and its packing from the same material at the same time in this manner, manufacturing costs may be decreased

The base portion 110 has an upper surface 103 and a lower surface opposite the upper surface 103. The base portion 110 also has a top edge 180 and a bottom edge 182. Adjacent the top edge 180 is a first line of weakness 160 formed in the sheet 101. As used herein, “line of weakness” means a line along which the tear strength of the sheet 101 is lower relative to the tear strength elsewhere in the sheet 101. This first line of weakness 160 crosses both the base portion 110 and the first lateral portion 120. Similarly, a second line of weakness 165 is disposed adjacent the bottom edge 182 and crosses both the base portion 110 and the first lateral portion 120. Preferably the first and second lines of weakness 160, 165 are parallel to the respective top and bottom edges 180, 182 of the base portion 110. The top and bottom base edges 180, 182 may be substantially parallel to one another. The lines of weakness 160, 165 may be created by perforating the sheet 101, or by any other means of lowering the tear strength of the sheet 101 along a line.

The sheet 101 is foldable to create a secure data card package, which may then be sold to consumers at retail locations, for example. The second lateral portion 130 is folded along a first fold line 107 toward the upper surface 103 of the base portion 110 to a stowed position, as shown in FIG. 2. Although the second lateral portion 130 is integral with the sheet 101, the first fold line 107 may be treated, such as by perforation or scoring, to facilitate ready detachment of the second lateral portion 130 from the base portion 110. The second lateral portion 130 may itself be a data card and the ready detachment of the second lateral portion 130 may be desirable for carrying the data card in a wallet or purse, for example.

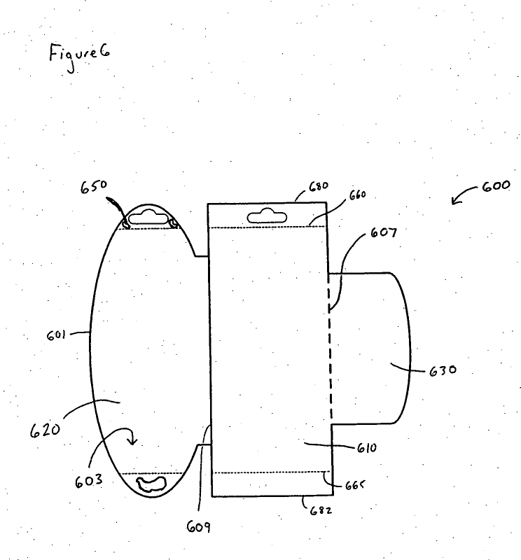

Alternatively, as discussed later with respect to FIGS. 5a and 5b, in some embodiments, a data card may be formed from a sub-portion of the second lateral portion 130. The data card sub-portion may be made readily detachable from the second lateral portion 130 through the use of perforation or scoring.

The first lateral portion 120 is folded along a second fold line 109 toward the upper surface 103 of the base portion 110 to a covering position wherein the first lateral portion 120 overlays at least a portion of the base portion 110. When the second lateral portion 130 is in its stowed position and the first lateral portion 120 is in its covering position, at least a portion of the second lateral portion 130 is disposed intermediate the base portion 110 and the first lateral portion 120.

The second fold line 109 is preferably perpendicular to the first and second lines of weakness 160, 165 so that when the first lateral portion 126 is in its covering position, the segments of the lines of weakness 160, 165 on the first lateral portion 120 are substantially lined up with the segments of the lines of weakness 160, 165 on the base portion 110.

Although shown in FIG. 1a as rectangular, the second lateral portion 130 may be of any shape or dimension. It should be appreciated that the second lateral portion 130 may have any length, where the length is defined as a dimension parallel to first fold line 107. If the length is greater than the distance between the first and second lines of weakness 160, 165, these lines of weakness extend across the second lateral portion 130 in addition to the base and first lateral portions 110, 120. Preferably, the dimensions of the second lateral portion 130 are such that when the second lateral portion 130 is in the stowed position and the first lateral portion 120 is the covering position, the second lateral portion 130 is completely concealed from view. This concealment may help deter theft as the second lateral portion 130 may not be readily visible or removable from its stowed position intermediate the base portion 110 and the first lateral portion 120 in its covering position.

An adhesive 150 may be disposed on a portion of the upper surface 103 of either the base portion 110, or the first lateral portions 120, or both, intermediate the first line of weakness 160 and the top edge of the base portion 180 and intermediate the second line of weakness 165 and the bottom edge of the base portion 182. When the sheet 101 is folded such that the second lateral portion 130 is in its stowed position and the first lateral portion 120 is in its covering position, the adhesive 150 seals the assembly in its folded form to create a secure package.

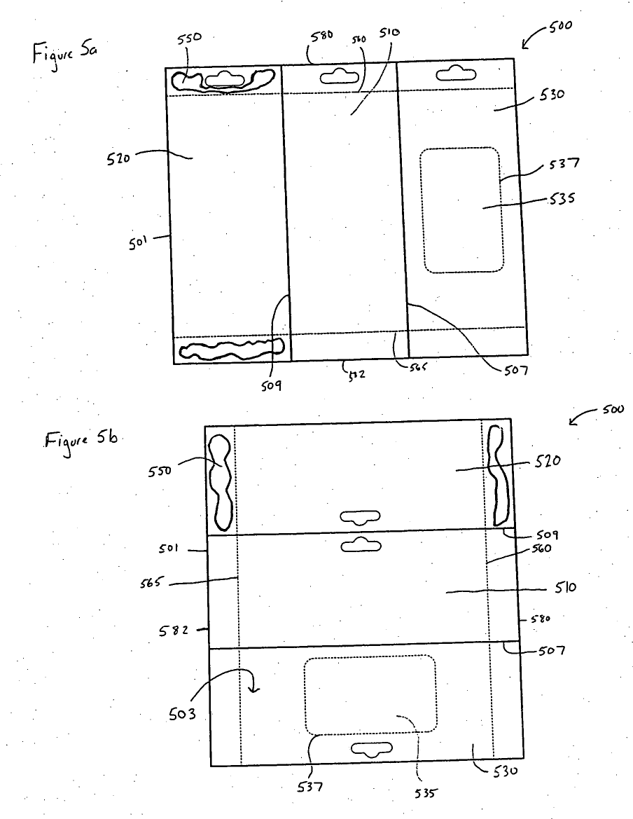

The assembly in its folded form has a top tear section 102 and a bottom tear section 104, as shown in FIG. 4. The top tear section 102 is defined by that portion of the sheet 101 between the first line of weakness 160 and the top edge 180. The bottom tear section 104 is defined by that portion of the sheet 101 between the second line of weakness 165 and the bottom edge 182. As discussed elsewhere, these are also the sections of the sheet 101 which contain the adhesive 150 which seals the assembly. As a result of the alignment of the segments of the lines of weakness 160, 165 on the first lateral portion 120 and the base portion 110, the tear sections 102, 104 can easily be removed along these lines of weakness.

Once sealed, to gain access to the second lateral portion 130, which may be or may include a data card, the package may be opened by removing the tear sections 102, 104 at the lines of weakness 160, 165. With the adhesive-containing tear sections removed, the assembly may be opened to reveal the three portions of the sheet. The second lateral portion 130 may then be removed if the first fold line 107 is perforated or scored so a purchaser may easily carry the second lateral portion 130, and hence the data card, without the need to carry the entire assembly.

The sheet 101 may contain indicia, such as verbiage for using a data card, advertisements, terms and conditions, or other information on any or all of the portions and on either or both surfaces of the sheet. In particular, the second lateral portion 130 may have indicia corresponding to any type of data card, such as calling card, for example. The information may still more preferably include an identification number which may be used to identify an account corresponding to the data card which contains a value which is debited as the data card is used. In the case of a calling card, additional information such as a telephone number to access the user's account may be printed on the card.

Further security may added to the assembly by printing the identification number on the upper surface 103 of the second lateral portion 130, so that when the second lateral portion 130 is in its stowed position, the identification number opposes the upper surface 103 of the base portion 110.

Still more security may be added to the data card by coating the identification number with a scratch-off coating or label scratch-offs such as a hot-stamp scratch-off as is well known in the art, and which are easily removable by a purchaser to reveal the identification number once the assembly has been opened.

If verbiage is printed on the sheet 101, it may be parallel to the top and bottom base edges 180, 182, or it may be perpendicular to the top and bottom base edges 180, 182. Alternatively the verbiage may be in any orientation or a combination of orientations.

The sheet 101 may still further include indicia relating to data card activation. This indicia may be on the lower surface of the base portion 110 or the first lateral portion 120, as the upper surface of the base portion 110 and the first lateral portion 120 are concealed from view when the assembly is folded and sealed. Accordingly, placing activation indicia on the lower surface of the base portion 110 or the first lateral portion 120, permits the indicia to be exposed so that the data card may be activated, such as at a cash register for example, when purchased without opening the assembly. Alternatively, in some exemplary embodiments the activation information may be contained on either surface of the second lateral portion 130.

The activation information may include a magnetic strip, bar code, smartchip, SIMS card or any other marking capable of being encoded with information that identifies the data card. The activation information may contain a serial number, a UPC, a vendor identification number, a value, and any other type of card identifiable information. The activation information may preferably be used to activate the data card according to the methods described in U.S. Pat. No. 5,777,305 to Smith et al. or the methods described in U.S. Application Ser. No. 09/641,363 to Graves et al., both of which are herein incorporated by reference.

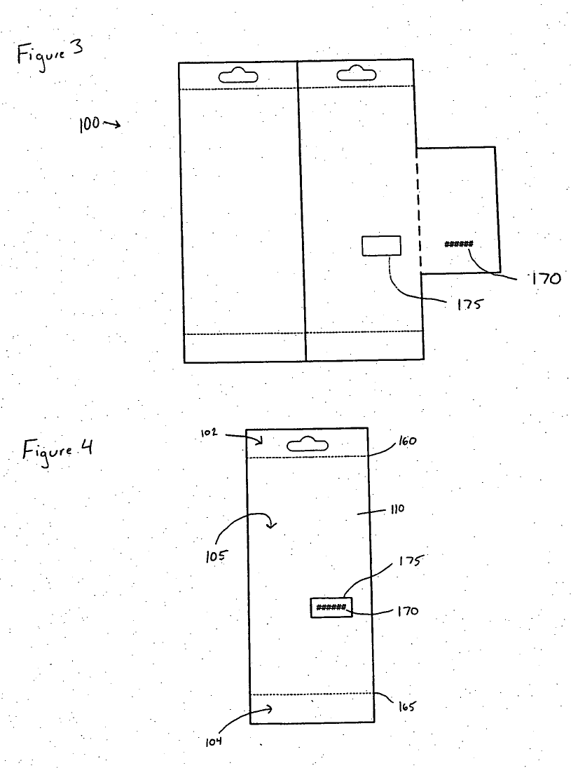

FIG. 3 shows an exemplary embodiment of the present invention where the card activation information 170 is on the upper surface 103 of the second lateral portion 130 of the sheet 101. Either the base portion 110 or the first lateral portion 120, or both, may contain an aperture or window 175. The aperture is located and dimensioned to correspond to the activation information 170, such that when the second lateral portion 130 is in its stowed position, and the first lateral portion 120 is in its covering position, as shown in FIG. 4, the activation information 170 is viewable through the aperture 175 to facilitate activation, such as at a cash register, for example. The remaining information on the second lateral portion 130 may still be hidden from view unless and until the assembly is opened as described above.

Yet another exemplary embodiment is shown in FIGS. 5a and 5b. These exemplary embodiments demonstrate when the second lateral portion 530 has a length equal to the distance between the top and bottom edges 580, 582 of the base portion 510. Lines of weakness 560, 565 extend across second lateral portion 530 as well as the base portion 510 and the first lateral portion 520. The second lateral portion 530 may further include a data card portion 535 which may be detachable from second lateral portion 530, such as by a third line of weakness 537 forming the perimeter of the data card portion 535.

In this embodiment, information regarding use of the data card, such as the identification number, may preferably be contained entirely within the data card portion 535 of the second lateral portion 530.

Yet another exemplary embodiment is shown in FIG. 6. Although the base, first lateral, and second lateral portions may be substantially rectangular, these shapes are not necessary for an assembly to fall within the scope of the invention. As shown in FIG. 6, the invention may work equally well with other shapes, as long as the lines of weakness 660, 665 cross the base and first lateral portions 610, 620, so that the segments of the lines of weakness 660, 665 of the base portion 610 are aligned with the segments of the lines weakness 660, 665 of the first lateral portion 620 when the first lateral portion 620 is in its covering position. When the assembly is sealed, a user may open the assembly to gain access to the second lateral portion 630 by removing those areas of the sheet 601 which are sealed above and below the lines of weakness as described earlier in relation to the tear sections.

The present invention is not to be limited in scope by the specific exemplary embodiments described herein. Indeed, various modifications of the present invention, in addition to those described herein, will be apparent to those of ordinary skill in the art from the foregoing description and accompanying drawings. Thus, such modifications are intended to fall within the scope of the following appended claims. Accordingly, the claims set forth below should be construed in view of the full breath and spirit of the present invention as disclosed herein.

1. A foldable data card assembly comprising:
a sheet having an upper and lower surface
a base portion having spaced apart first and second lateral sides and spaced apart top and bottom base edges;
a first lateral portion extending laterally away from the first lateral side of the base portion;
a second lateral portion extending laterally away from the second lateral side of the base portion,
a first line of weakness formed in the base portion and the first lateral portion, the first line of weakness being substantially parallel to the top base edge;
a second line of weakness formed in the base portion and the first lateral portion, the second line of weakness being substantially parallel to the bottom base edge; and
an adhesive disposed on at least a portion of an area of the upper surface of the base portion intermediate the first line of weakness and the top base edge and on at least a portion of an area of the upper surface of the base portion intermediate the second line of weakness and the bottom base edge,
wherein the second lateral portion is foldable along a first fold line to a stowed position wherein the second lateral portion overlies at least a portion of the upper surface of the base portion and wherein the first lateral portion is foldable along a second fold line to a covering position wherein the first lateral portion overlies at least a portion of the second lateral position when the second lateral portion is in its stowed position.

2. The assembly of claim 1, wherein the second fold line is perpendicular to the first and second line of weakness.

3. The assembly of claim 1 wherein the second lateral portion is detachably connected to the base portion.

4. The assembly of claim 1, wherein the top and bottom base edges are parallel straight lines.

5. The assembly of claim 1, wherein the distance of the second lateral portion perpendicular to the distance between the top and bottom edge is equal to or less than the distance perpendicular to the distance between the top and bottom edge of the central portion or first lateral portion.

6. The assembly of claim 5 wherein the distance perpendicular to the distance between the top and bottom edge of the central portion and first lateral portion are equal.

7. The assembly of claim 1, wherein the sheet contains indicia.

8. The assembly of claim 7, wherein the indicia corresponds to a telephone calling card.

9. The assembly of claim 8, wherein the indicia further corresponds to telephone calling card activation.

10. The assembly of claim 8, wherein the indicia further corresponds to an identification number for calling card verification.

11. The assembly of claim 10, wherein the identification number for calling card verification is coated with a removable scratch-off coating which conceals the identification number from view.

12. The assembly of claim 7 wherein the indicia is parallel to the lines of weakness.

13. The assembly of claim 7 wherein the indicia is perpendicular to the lines of weakness.

14. The assembly of claim 1 wherein at least one of the base portion and first lateral portion contain an aperture.

15. The assembly of claim 14 wherein a portion of the second lateral portion is visible through the aperture when the second lateral portion is in the stowed position and the first lateral portion is in the covering position.

16. The assembly of claim 15 wherein the visible part of the second lateral portion contains indicia for activation of a data card.

17. The assembly of claim 1 wherein the second lateral portion is a data card.

18. The assembly of claim 1, the second lateral portion further comprises a line of weakness defining a perimeter of an integral, detachable data card.

19. A foldable data card assembly comprising:
a sheet having
a base portion having spaced apart first and second lateral sides, spaced apart top and bottom base edges and upper and lower base surfaces, the top and bottom base edges substantially parallel to one another;
a first lateral portion extending laterally away from the first lateral side of the base portion;
a second lateral portion containing indicia relating to a data card extending laterally away from the second lateral side of the base portion, the second lateral portion being substantially rectangular having a length parallel to the base portion less than or equal to a distance between the top and bottom base edges and having a width less than or equal to a distance separating the second lateral portion from the first lateral portion;
a first line of weakness formed in the base portion and the first lateral portion, the first line of weakness being substantially parallel to the top base edge;
a second line of weakness formed in the base portion and the first lateral portion, the second line of weakness being substantially parallel to the bottom base edge; and
an adhesive disposed on at least a portion of an area of the upper surface of the base portion intermediate the first line of weakness and the top base edge and on at least a portion of an area of the upper surface of the base portion intermediate the second line of weakness and the bottom base edge,
wherein the second lateral portion is foldable along a first fold line to a stowed position wherein the second lateral portion overlies the upper surface of the base portion and wherein the first lateral portion is foldable along a second fold line perpendicular to the first and second lines of weakness to a covering position wherein the first lateral portion overlies the second lateral position when the second lateral portion is in its stowed position.
